(19) United States
(12) Patent Application Publication
(10) Pub. No.: US 2010/0285386 A1
(43) Pub. Date: Nov. 11, 2010

(54) HIGH POWER FUEL STACKS USING METAL SEPARATOR PLATES

(75) Inventor: Conghua Wang, West Windsor, NJ (US)

Correspondence Address: DLA PIPER LLP (US);ATTN: PATENT GROUP, P.O. Box 2758, Reston, VA, 20195, US

(73) Assignee: TREADSTONE TECHNOLOGIES, INC., Princeton, NJ (US)

(21) Appl. No.: 12/777,126

(22) Filed: May 10, 2010

Related U.S. Application Data
(60) Provisional application No. 61/176,550, filed on May 8, 2009.

(51) Int. Cl. H01M 8/24

(52) U.S. Cl. 429/457

(57) ABSTRACT

A separator plate for use in a fuel cell stack in a fuel cell device includes a porous core with a metal layer on either side of the porous core. The metal layer has through holes formed therein such as by perforation. The metal layers are contoured to provide flow field channels, and the porous layer may have channels formed therein that are parallel to the metal layers that can be used for cooling water. A monopolar fuel stack includes twin cell units that include a center separator plate, a pair of membrane electrode assemblies, one on each side of the center separator plate, and a pair of outer plates which may have through holes formed therein, one on each side of the membrane electrode assemblies opposite the center separator plate. The outer plates cover substantially an entire electrode to which they are adjacent.

### CROSS REFERENCE TO RELATED APPLICATIONS

This application claims priority from U.S. Provisional Application Ser. No. 61/176,550 filed May 8, 2009. The entirety of that provisional application is incorporated herein by reference.

### BACKGROUND

Fuel cell-based power system technology is a promising, highly efficient electricity generation technology. This technology has been demonstrated in various applications. Among all type of fuel cells, low temperature (typically 50°-80° C.) fuel cells, such as Nafion-based proton exchange (polymer electrolyte) membrane (PEM) fuel cells, have demonstrated the broadest market potential in portable, stationary and automobile applications.

The core component of low temperature fuel cell power systems is the fuel cell stack that converts the chemical energy of the fuel to electrical energy through electrochemical reactions. Each fuel cell stack comprises multiple fuel cells to deliver high power (voltage and current) for various applications. Each fuel cell include an electrolyte membrane with a cathode electrode on one side and an anode electrodes on the opposite side (collectively referred to as the membrane electrode assembly, or MEA) for electrochemical reactions, and gas diffusion layers (GDL) adjacent to each of the electrodes for gas diffusion in and out of electrodes. This combined MEA and GDL structure is sometimes referred to as the MEA/GDL. The cells in a stack are separated by separator plates. The separator plates, as the structural components of the fuel cell stack, have two major functions. The first is to serve the electrical connector between cells; the other is the fuel and air separator in the stack.

The most common high power fuel cell stack design is based on a bipolar separator plate structure, wherein each separator plate is in contact with the GDL adjacent an anode (fuel electrode) on one side, and the GDL adjacent a cathode (air electrode) on the other side, as disclosed in U.S. Pat. No. 3,134,696. Electrons generated from the electrode reactions vertically pass through the body of the separator plate to connect the adjacent cells. The bipolar separator plate has flow channels for air and fuel distribution on the outer surfaces of the plate, and in some embodiments has cooling channels (which may conduct water or another thermally conductive substance) inside the plates for the thermal management of the stack, as disclosed in U.S. Pat. No. 3,392,058.

The common bipolar separator plate is made of solid materials, such as graphite, or graphite/polymer composite. This type of fuel cell stack has the advantage of a simple structure. However, the challenge of this stack design is the difficulties of removing liquid water on the cathode, resulting in the flooding of cathode. The flooding blocks the airflow to the cathode, which leads to the degradation of fuel cell performance. The possible solutions to the flooding issue in solid bipolar plates can be proper, complicated flow field design, as disclosed in U.S. Pat. No. 5,773,160, and high flow rate unsaturated air to remove water from flow field channels, as disclosed in U.S. Pat. No. 5,441,819.

Another type of bipolar separator plate has a porous structure. The pores wick the liquid water out of cathode by capillary action, and keep the gas flow field channels free of liquid water, as disclosed in U.S. Pat. No. 4,876,162, and U.S. Pat. No. 4,543,303. This stack design has excellent water management capability during stack operation. The challenge with this stack design is the high cost to fabricate the plates with the micro-sized porous structure necessary to keep high “bubble pressure” for the water management.

Another type of fuel cell stack is the so-called mono-polar fuel cell stack, as disclosed in U.S. Pat. No. 7,585,577. Both sides of the separator plates in this type of stack are in contact with the same gas (fuel or air). Electrons generated from the electrode reaction flow through the electrode, gas diffusion layer or separator plates in planar directions relative to the edge of the cell, and are connected to the adjacent cells on the sides of the cells. The challenge of this stack design is the long passage for electron transport through the electrode, resulting the high internal electrical resistance. Therefore, this stack design is mainly used for low power fuel cell stacks.

Therefore, there is a need for advanced high power fuel cell stack designs that can effectively manage water transport in the stack, and have low component fabrication and stack assembly cost.

### BRIEF DESCRIPTION OF THE DRAWING

FIG. 1 is a schematic drawing of a bipolar fuel stack.

FIG. 2A is a schematic drawing of the cross section of a composite metal separator plate with center channels according to one embodiment.

FIG. 2B is a schematic drawing of the cross section of a composite metal separator plate without center channels according to a second embodiment.

FIG. 3 is a schematic drawing of the cross section of a fuel cell stack using composite metal separator plates of FIG. 2A to build a bipolar plate structured stack according to a third embodiment.

FIG. 4A is a schematic drawing of the cross section of a twin-cell unit with a composite metal plate with the center channel as the center plate, and metal plates as the outside plates according to a fourth embodiment.

FIG. 4B is a schematic drawing of the cross section of the twin-cell unit with a composite metal plate without the center channel as the center plate, and metal plates as the outside plates according to a fifth embodiment.

FIG. 4C is a schematic drawing of the cross section of the twin-cell unit with a metal plate as the center plate and metal plates as the outside plates according to a sixth embodiment.

FIG. 5 A is a schematic drawing of the cross section of a fuel cell stack using the twin-cell units with solid metal outside walls according to a seventh embodiment.

FIG. 5B is a schematic drawing of the cross section of a fuel cell stack using the twin-cell units with perforated metal outside walls according to an eighth embodiment.

### DETAILED DESCRIPTION

In the following detailed description, a plurality of specific details, such as types of materials and dimensions, are set forth in order to provide a thorough understanding of the preferred embodiments discussed below. The details discussed in connection with the preferred embodiments should not be understood to limit the present inventions. Furthermore, for ease of understanding, certain method steps are delineated as separate steps; however, these steps should not be construed as necessarily distinct nor order dependent in their performance.

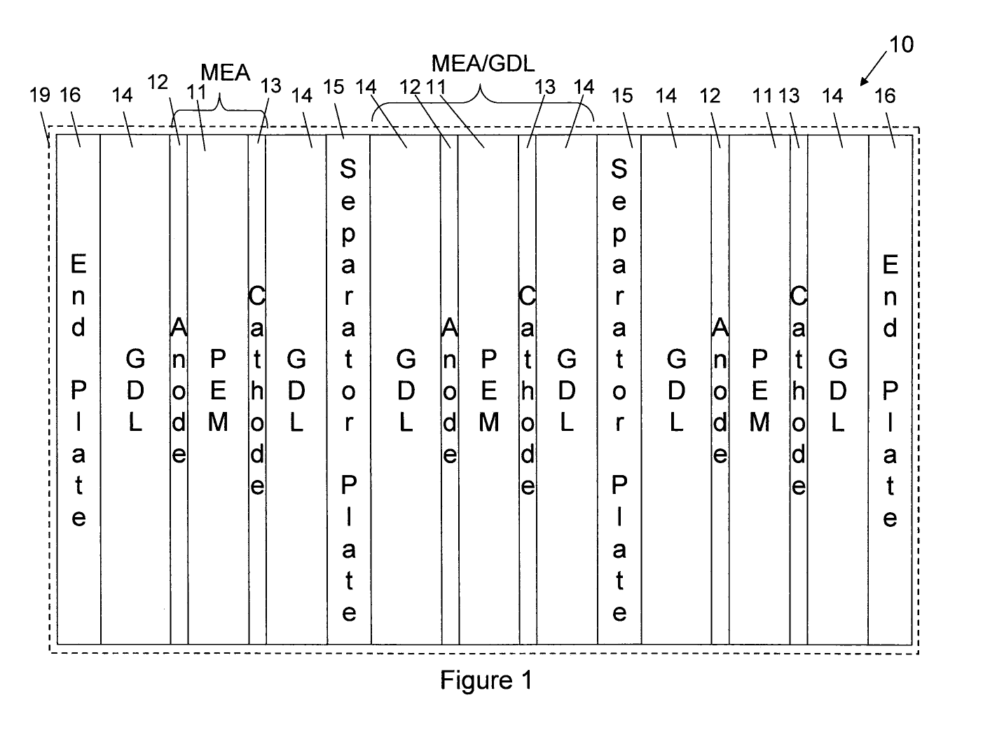

A fuel cell stack 10 disposed in a container 19 is shown in FIG. 1. The fuel cell stack 10 includes three MEA/GDLs, each comprising a proton exchange membrane 11 with an anode 12 and a cathode 13 on opposite sides of the PEM 11 to form MEAs, and gas diffusion layers 14 adjacent the MEAs on opposite sides. Separator plates 15 are disposed between adjacent MEA/GDLs, and end plates 16 are present on opposite ends of the fuel stack 10 formed by the three MEA/GDLs. The separator plates 15 are referred to as bi-polar separator plates as they have an anode 12 on one side and a cathode 13 on the other. Fuel cell stacks with mono-polar separator plates in which the anode and cathode are swapped in adjoining MEAs are also known in the art as discussed above. Either of these types of fuel cell stacks may be combined with additional components (manifolds, etc., not shown in FIG. 6) to form fuel cell devices as is well known in the art.

An improved separator plate useful in fuel stacks such as those described above is built as a composite plate with at least one perforated outer metal layer and an inner layer of porous material. The outer surface of the metal layer is in contact with the MEA/GDL to transport electrons for electrode reaction, and gas distribution, through channels formed by the metal layer. At least one of the metal outer layers has through holes for water or moisture transport between the inner porous layer and the electrode on the metal outer surface. The through holes could be formed using perforated metal, expanded metal, or chemically etched metal techniques or by any other means. The porous layer is used to wick water out of electrode/GDL and flow field channels using capillary action, and transport extra water out of fuel cell active area through the porous sheet using gravity. The liquid water wicked in the porous layer will also evaporate back to the gas channels, keeping a high relative humidity (which could be over 50%, over 75%, over 90% or close to 100%) all cross the electrode active areas, including hot areas and hot spots, to prevent the de-hydration of the electrolyte membrane. The material in the porous layer may be polymer, ceramic, carbon, or any other low cost, non-metallic material. In preferred embodiments, the porous material is electrically non-conductive.

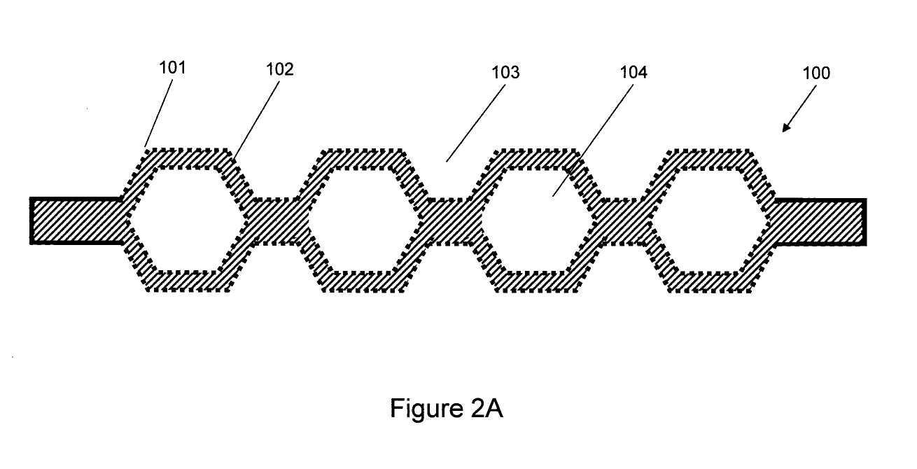

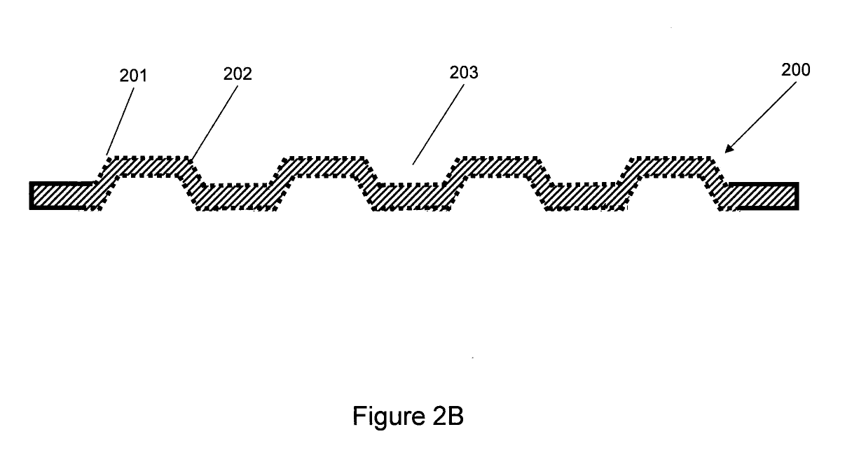

In one embodiment, two formed metal sheets 101, and two porous layers 102 are joined together to form a composite metal separator plate 100 as shown in FIG. 2A. At least one of the metal sheets 101 has through holes at the center. The porous layer 102 is attached on the back sides of the perforated metal sheets 101 between the two perforated metal sheets 101. Flow field channels 103 on the surfaces of the composite metal plates 100 facilitate fuel cell electrode reactions. The center channel 104 is for cooling water, or serves as the pre-heating/pre-humidifying channels for feeding gases. Two metal sheets 101 may be joined together at the edge by welding, clamping or any other suitable means. This composite metal plate 100 may be used in both bi-polar and mono-polar fuel cell stacks.

In another embodiment, two formed metal sheets 201 and one porous layer 202 are joined together to form a composite metal separator plate 200, as shown in FIG. 2B. At least one of the metal sheets 201 has through holes at the center. The porous layer 202 is attached on the back sides of the metal sheets 201, between the two metal sheets 201. The flow-field channels 203 on the surface of the composite metal plates 200 facilitate fuel cell electrode reactions. Two metal sheets 201 may be joined together at the edge by welding, clamping or other means. This composite metal plate 200 is mainly used for monopolar structured fuel cell stacks, although it could be used as the separator plates for bipolar structured fuel cell stacks.

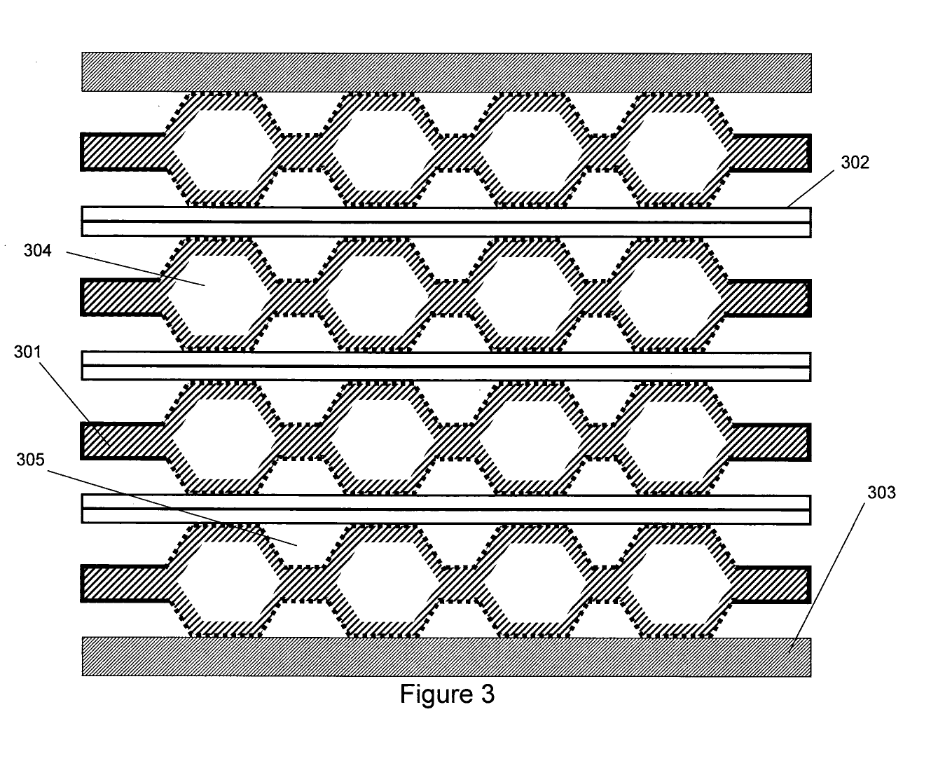

In some embodiments, the composite metal plate 100 of FIG. 2A (shown as 301 in FIG. 3) is used as bipolar separator plates to build a fuel cell stack 300 as shown in FIG. 3. The fuel stack 300 includes an MEA/GDL 302 for electrode reactions. End plates 303 are provided on each end of the stack 300. The composite metal plate 301 includes center channels 304 for cooling water (same as 104 in FIG. 2A), and flow field surface channels 305 (same as 103 in FIG. 2A) for gas distribution. In the stack 300, one side of the composite metal plates 301 is in contact with the cathode of one adjacent cell, and the other side of the composite plate 301 is in contact with the anode of the other adjacent cell. Water generated from the electrode reactions will be wicked away from the electrode and gas flow field channel 305, and carried away from the stack 300 with the cooling water in center channel 304. The small pore size of the porous layer of the composite metal plate 301 will keep the water inside the center channel 304, without flooding the gas flow field channels 305.

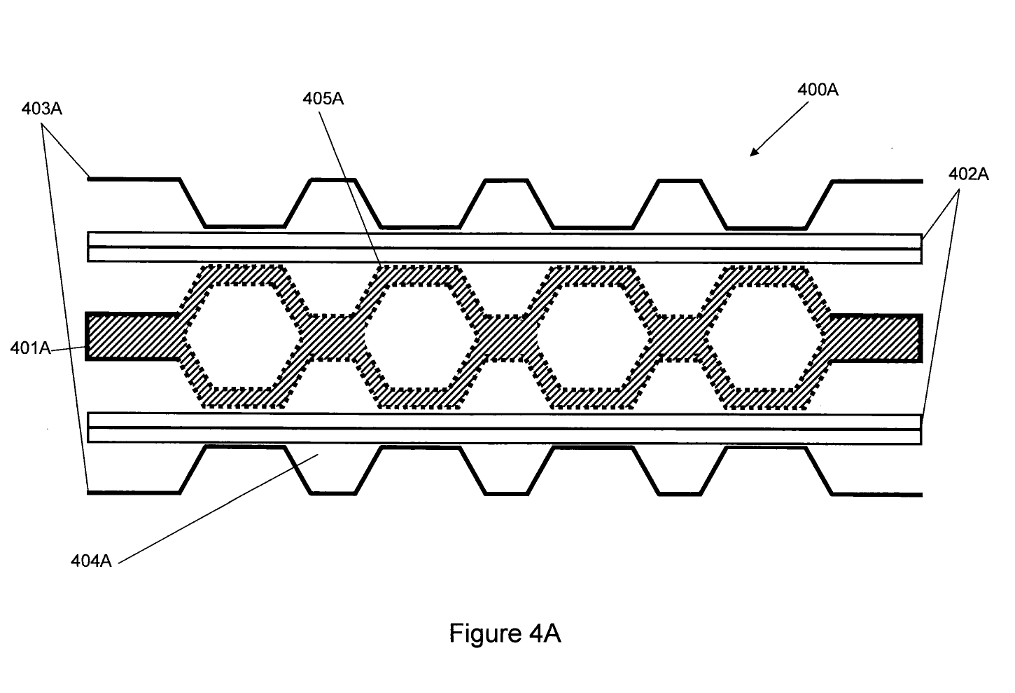

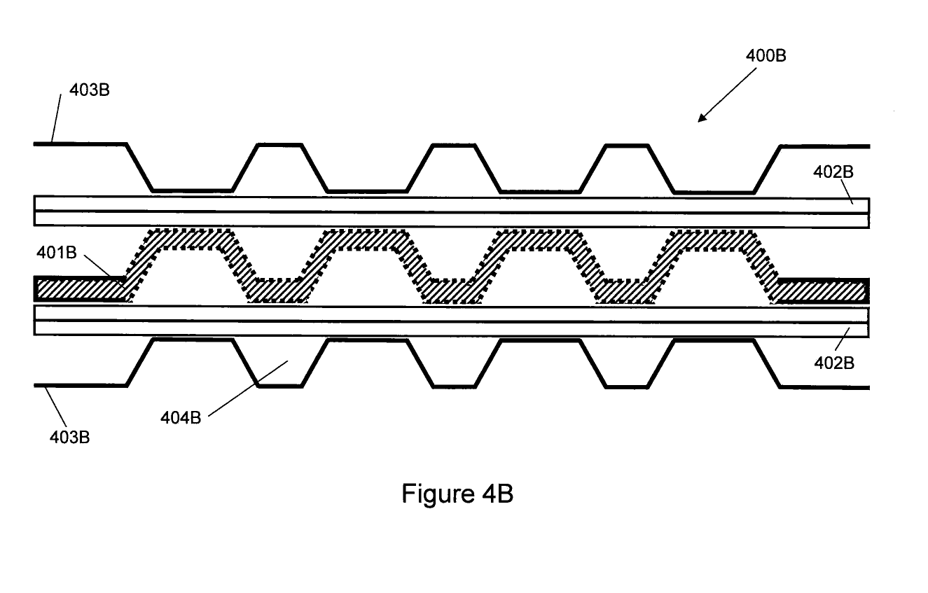

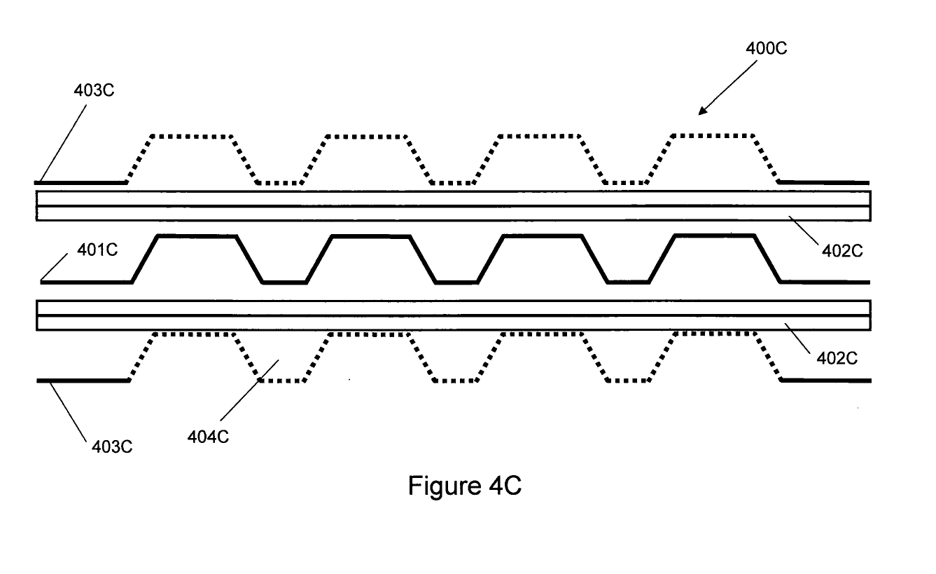

In another embodiment of the invention, the composite metal plate 100 is used as the center plate to construct a twin-cell unit 400A, as shown in FIG. 4A. The center metal plate 401A is the composite metal plate with the center channels (same as 100 in FIG. 2A). The twin cell unit 400A includes two MEA/GDLs 402A for electrode reactions. The center metal plate 401A is in contact with the same electrode (cathode or anode) of the two MEAs 402A and functions as the separator of two MEAs and the electrical current collector for electrode reactions on the electrodes. One of two outside metal plates 403A is in contact with each of the other electrodes of the MEAs 402A. The two outside metal plates 403A sandwich the center composite metal plate 401A and two MEA/GDLs 402A to build a solid twin-cell unit 400A. The outside plates 403A function as the electrical current collectors and provide mechanical support for the whole twin cell structure. The outside metal plates 403A may be solid (i.e., no through holes) or may have through holes. The outside metal plates 403A may be joined at the edges by welding, clamping or other means or may be electrically connected by an additional member (not shown in FIG. 4A). The channels 404A on both sides of the MEA/GDLs 402A are gas (fuel and air) distribution channels. The center channel 405A of the composite plate 401A could be used as the pre-heating and pre-humidifying channel for the input gases. The twin cell unit 400A is the basic unit for mono-polar separator plate structured fuel cell stacks.

In another embodiment of the invention, the composite metal plate 200 is used as the center separator/current collector plate to construct a twin-cell unit 400B, as shown in FIG. 4B. Each twin-cell unit 400B includes two MEA/GDLs 402B and a center metal separator/current collector plate 401B (which is the same as the plate 200 of FIG. 2B) positioned such that it is in contact with the same electrode (cathode or anode) of each of the two MEA/GDLs 402B. Outside metal current collector plates 403B are in contact with the other electrode of the MEA/GDLs 402B. The two outside metal current collector plates 403B sandwich the center composite metal plate 401B and two MEA/GDLs 402B to form and provide structural support the solid twin-cell unit 400B. The outside metal plates 403B may be joined at the edges by welding, clamping or other means, or may be electrically connected by an additional member (not shown in FIG. 4B). The flow field channels 404B on both sides of the MEA/GDL 402B are gas (air and fuel) distribution channels. The twin cell unit 400B is the basic unit for mono-polar separator plate structured fuel cell stacks.

In one further embodiment of the invention, a metal plate 401C is used as the center separator/current collector plate to construct a twin-cell unit 400C, as shown in FIG. 4C. The center metal separator/current collector plate 401C is a simple metal sheet without a porous layer. Each twin cell unit 400C includes two MEA/GDLs. Center metal separator/current collector plate 401C is in contact with the same electrode (cathode or anode) of the adjacent MEAs. Outside metal current collector plates 403C are in contact with the other electrode of the MEAs 402C, and have through holes (formed by any of the methods discussed above) at the active area for gas transport. Outside metal current collector plates 403C also provide structural support for the fuel cell 400C. The two outside metal current collector plates 403C sandwich the center metal plate 401C and the two MEA/GDLs 402C to form a solid twin-cell unit 400C. The outside metal current collector plates 403B may be joined at the edges by welding, clamping or other means, or may be electrically connected by an additional member (not shown in FIG. 4C). The flow field channels 404C on both sides of the MEA/GDL 402C are gas (air and fuel) distribution channels. The twin cell unit 400C is the basic unit for mono-polar separator plate structured fuel cell stacks.

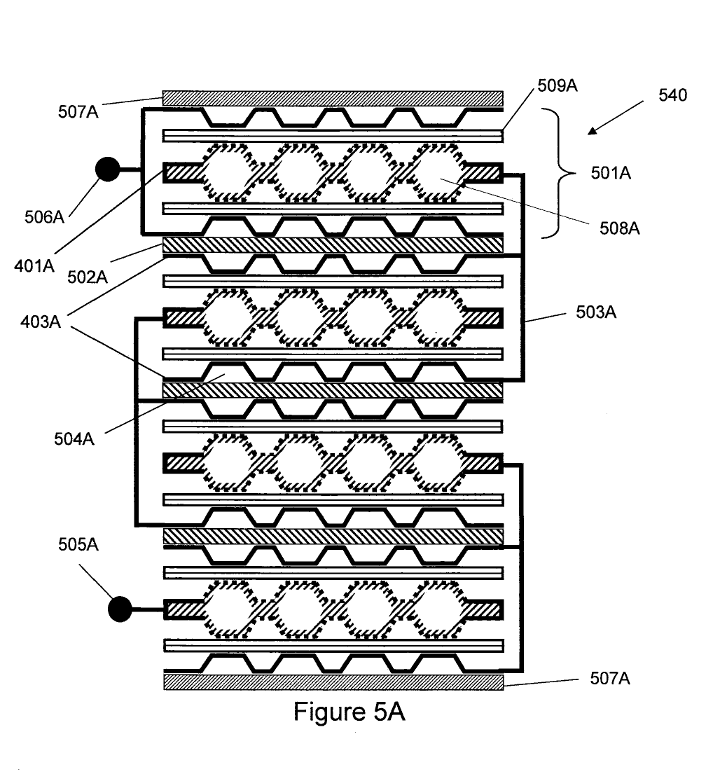

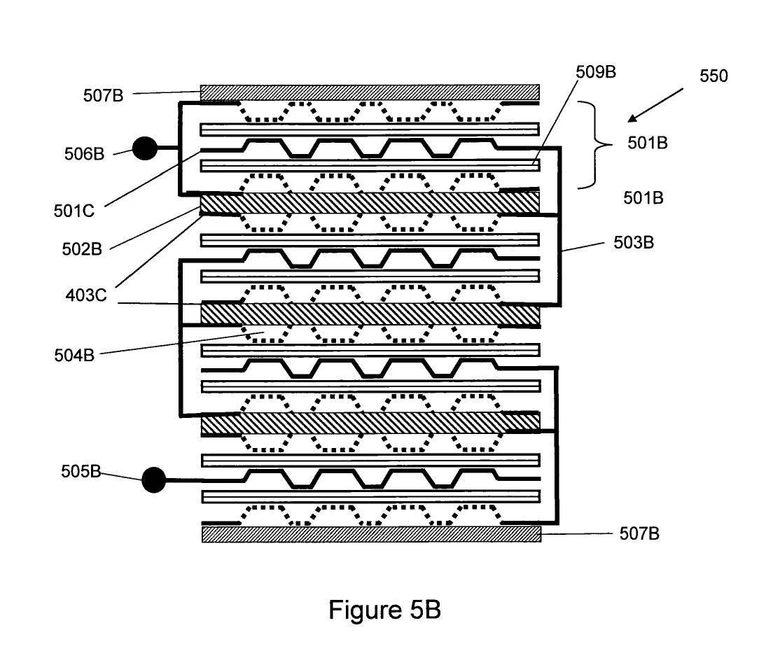

In one embodiment of the invention, the twin cell unit 400A (or 400B) is used to build a monopolar fuel cell stack 540, as shown in FIG. 5A. An electrically insulating spacer 502A separates adjacent twin cell units 501A (which are the same as the twin cell units 400A of FIG. 4A in some embodiments or are the same as the twin cell units 400B of FIG. 4B in other embodiments). An electrical conductor 503A connects the center metal separator/current collector plate 401A of one twin cell unit 501A to the outer metal current collector plates 403A of the adjacent twin cell unit 501A. Channels 504A (out of the twin cell units) are coolant channels. The connectors 505A and 506A are the electrical power outputs for the stack. 507A is the end plate of the stack. Center channel 508A of the twin cell unit 501A provides for water flow. Preferably, the cathode (air electrode) of the MEA 509A faces the center part of the twin cell unit 501A, and the anode (fuel electrode) faces the side of the twin cell unit 501A. During operation, the water will flow through the center channel 508A to maintain the cathode humidity and carry produced water away. Coolant flows through cooling channel 504A to carry heat away from the twin cell unit 501A. The anode temperature will be lower than the cathode temperature, which will enhance the water diffusion from cathode side to the anode side keeping the electrolyte membrane properly humidified during operation.

In another embodiment of the invention, the twin cell unit 400C is used to build an open cathode mono-polar fuel cell stack 550, as shown in FIG. 5B. In the mono-polar fuel stack 550, an electrically insulating spacer 502B separates adjacent twin cell units 501B (which are the same as twin cell units 400C shown in FIG. 4C). An electrical conductor 503B connects the center metal separator/current collector plate 501C of one twin cell unit 501B to the outer metal current collector plates 403C of the adjacent twin cell unit 501B. In this stack, the anode of the MEA 509B faces to the center part of the twin cell unit 501B, and the cathode faces to the outside of the twin cell unit 501B. The outer metal plates 503 preferably cover substantially the entirety of the active area (i.e., more than 75%, preferably more than 90% and more preferably more than 95%) of the cathode, with the exception of areas not covered by the through holes formed in the outer metal plates 503. Channels 504B (out of the twin cell units 501B) are used to deliver air for the cathode reaction and stack cooling. The connectors 505B and 506B are the electrical power outputs of the stack. End plates 507B are provided at opposite ends of the stack.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A fuel cell stack comprising:
at least two fuel cells separated by a composite separator plate, the composite separator plate including a non-metallic porous core, a first metal layer on a first side of the porous core and a second metal layer on a second side of the porous core opposite the first side;
wherein the first metal layer is joined to the second metal layer, and wherein at least one of the first and second metal layers have through holes formed therein to allow fluid communication with the porous core, and wherein the first and second metal layers have flow field channels formed in outer surfaces thereof.

2. The fuel cell stack of claim 1, wherein the porous core of the separator plate has channels formed therein in a direction parallel to the metal layers.

3. The fuel cell stack of claim 2, wherein at least a portion of the channels of the porous core are parallel to the flow field channels formed in the outer surfaces of the first and second metal layers.

4. The fuel cell stack of claim 3, wherein contours of the channels of the porous core correspond to contours of the flow field channels formed in the outer surfaces of the metal layers.

5. The fuel cell stack of claim 1, wherein the porous core is ceramic.

6. The fuel cell stack of claim 1, wherein the porous core is polymer.

7. The fuel cell of stack claim 1, wherein the porous core is carbon.

8. The fuel cell stack of claim 1, wherein the porous core is formed from a material that is not electrically conductive.

9. The fuel cell device of stack 1, wherein the separator plate is a bi-polar separator plate with the first metal layer nearest to a first electrode in a first fuel cell having a polarity opposite that of a second electrode in a second fuel cell nearest to the second metal layer.

10. The fuel cell stack of claim 1, wherein the separator plate is a mono-polar separator plate with the first and second metal layers being nearest to electrodes of the same polarity in the two fuel cells.

11. The fuel cell stack of claim 1, wherein the fuel cell is a low temperature fuel cell.

12. The fuel cell stack of claim 1, wherein the fuel cell is a proton exchange membrane fuel cell.

13. A fuel cell device comprising:
a container; and
the fuel cell stack of claim 1 disposed within the container.

14. A separator plate for separating fuel cells in a fuel cell stack, the separator plate comprising:
a porous core formed from a non-metallic material;
a first metal layer on a first side of the porous core; and
a second metal layer on a second side of the porous core opposite the first side;
wherein the first metal layer is electrically connected to the second metal layer, and wherein at least one of the first and second metal layers have through holes formed therein to allow fluid communication with the porous core, and wherein the first and second metal layers have flow field channels formed in outer surfaces thereof.

15. The separator plate of claim 14, wherein the porous material is not electrically conducting.

16. The separator plate of claim 14, wherein the porous material has a channel formed therein in a direction parallel to the metal layers.

17. The separator plate of claim 14, wherein at least one edge of the first metal layer and at least one edge of the second metal layer are physically joined.

18. A twin mono-polar fuel cell comprising:
a first membrane electrode assembly having an electrode of a first type and an electrode of a second type;
a second membrane electrode assembly having an electrode of the first type and an electrode of the second type; and
a center separator/current collector plate positioned between the first membrane electrode assembly and the second membrane electrode assembly;
a first outer current collector plate positioned on a side of the first membrane electrode assembly opposite the center separator plate; and
a second outer current collector plate positioned on a side of the second membrane electrode assembly opposite the center separator plate;
wherein the first and second membrane electrode assemblies are positioned such that the electrode of the first type of each of the first and second membrane electrode assemblies are facing the center separator/current collector plate and wherein the first outer plate and the second outer plate cover substantially the entire active area of the electrodes of the second type.

19. The twin mono-polar fuel cell of claim 18, wherein the electrode of the first type is an anode, and wherein the first and second outer current collector plates have a plurality of through holes formed therein.

20. The twin mono-polar fuel cell of claim 18, wherein the electrode of the first type is a cathode.

21. The twin mono-polar fuel cell of claim 20, wherein the center separator/current collector plate is a composite plate including a non-metallic porous core, a first metal layer on a first side of the porous core and a second metal layer on a second side of the porous core opposite the first side, and wherein at least one of the first metal layer and the second metal layer has a plurality of through holes formed therein.

22. The twin mono-polar fuel cell of claim 18, wherein each face of the center separator/current collector plate forms flow field channels.

23. A fuel cell stack comprising:
a first twin mono-polar fuel cell according to claim 18;
a second twin mono-polar fuel cell according to claim 18; and
an electrically insulating plate positioned between the first twin cell unit and the second twin cell unit.
